(19) United States
(12) Patent Application Publication
(10) Pub. No.: US 2017/0286389 A1
(43) Pub. Date: Oct. 5, 2017

(54) Dynamic Generation of Electronic Forms and Documents

(71) Applicant: SEI Global Services, Inc., Oaks, PA (US)

(72) Inventors: Daniel Ceneviva, Trappe, PA (US); James Lewis, Gilbertsville, PA (US); John Roden, Apollo, PA (US)

(21) Appl. No.: 15/472,836

(22) Filed: Mar. 29, 2017

Related U.S. Application Data
(60) Provisional application No. 62/316,027, filed on Mar. 31, 2016.

(51) Int. Cl. G06F 17/24; G06F 17/21; G06F 17/22

(52) U.S. Cl. CPC G06F 17/248; G06F 17/2247; G06F 17/2264; G06F 17/243; G06F 17/212

(57) ABSTRACT

A user interface is configured to allow an end user to create an electronic form based on a template by identifying fields in the template to receive inputted data. The end user may also identify conditions specifying actions to be taken based on the data inputted into the fields and calculations to be performed on the data inputted into the fields. A conditional engine processor and a calculation engine processor are configured to create the electronic form based on the template and the identified fields in the template. A second user interface is provided and configured to display the electronic form and receive data input into the fields of the electronic form. Upon receiving data input into a field of the electronic form by an end user, the end user is directed to another field of the electronic form for inputting data, based on the data input into the field by the end user. A database stores data describing the electronic form separate from but associated with the data input into the fields of the electronic form. A processor generates a completed electronic form from the stored data describing the electronic form and the stored data input into the field of the electronic form stored in the database.

### CROSS REFERENCE TO RELATED APPLICATIONS

This application claims priority to U.S. Provisional Patent Application No. 62/316,027, filed Mar. 31, 2016, which is incorporated by reference herein in its entirety.

### FIELD OF THE INVENTION

The present description relates generally to data processing, and more particularly to improved methods, systems, and computer program product to lay out dynamic electronic forms and to generate digital form documents therefrom.

### BACKGROUND

There is an increasing demand for the ability to allow people to complete complex forms in an electronic interface, providing a more efficient, accessible, experience that also improves the ability to review and retrieve the information entered into the form. However, there remains a business need for the actual forms, in either a hard or soft copy format.

Systems to create dynamic digital form documents, such as PDF forms, are generally known. For example, an XML format called XFA (XML Forms Architecture) may be used to represent a dynamic PDF form, where all the dynamic form field elements are built into the PDF. At runtime, the actual form is rendered in real time with the PDF changing fields dynamically based on the previous form field data. However, the XFA file is completely self-contained and therefore inflexible.

Accordingly, there remains a need for technical improvements in the art.

### SUMMARY OF THE INVENTION

Aspects of the present invention are set out in the accompanying claims.

According to one aspect, the present invention provides a method of generating an electronic form suitable for display by an application on a device based on a template from a database of a server, said method comprising the steps of: receiving from the device a request for the electronic form; retrieving a template of the requested form, the template including document definition data defining at least one field element of the requested form; generating an electronic form suitable for display by the application on the device based on the retrieved document definition data, the form including at least one input element, corresponding to the at least one field element defined in the document definition data; transmitting at least a portion of the generated form to the device over a communication link for display by the device; receiving at least one data value associated with a respective input element of the generated form; and storing the received data values separate from but associated with respective field elements in the document definition data, wherein the stored document definition data and the associated stored data values can be used to generate a corresponding digital form document.

According to another aspect, the present invention provides a system and method for creating electronic forms. A user interface is configured to allow an end user to create an electronic form based on a template by identifying fields in the template to receive inputted data. The end user may also identify conditions specifying actions to be taken based on the data inputted into the fields and calculations to be performed on the data inputted into the fields. A conditional engine processor and a calculation engine processor are configured to create the electronic form based on the template and the identified fields in the template. A second user interface is provided and configured to display the electronic form and receive data input into the fields of the electronic form. Upon receiving data input into a field of the electronic form by an end user, the end user is directed to another field of the electronic form for inputting data, based on the data input into the field by the end user. A database stores data describing the electronic form separate from but associated with the data input into the fields of the electronic form. A processor generates a completed electronic form from the stored data describing the electronic form and the stored data input into the field of the electronic form stored in the database.

In accordance with another aspect, a method is provided to map specific data elements to a document form for the purpose of capturing information in a user friendly interface while having the capability to generate a completed form/document with precision. The method employs a set of common demographic data elements and user definable elements that can be configured specific to the document in use. The need for flexibility is paramount because the method is designed to be dynamic and accommodate any business document or form. Each data element contains a number of formatting options and configurations implemented through an interface that allows a user to further define the behavior of the field—e.g., required/optional field, definitions, data formatting, precision, and grouping functionality. In addition to the mapping of data elements, the method also incorporates the configuration of sections and groups so that the fields associated with the document can be ordered and displayed in a way that is desired by the individual designing the form without being confined to the structure of the document. The method seamlessly displays the sections, groups, and elements in a responsive design based on the formatting of the fields.

In accordance with another aspect of the present invention, a method is provided to allow for creation of dynamic conditions and calculations that will guide users through the completion of the form/document in accordance with the desired workflow. In order to increase efficiency and ensure data accuracy, the method is designed to transform documents dynamically based upon the information that the user is inputting and the different selections he makes. This is accomplished through robust conditionality and calculation functions that allow business users to create complex, nested business rules that, to date, have been hard coded on a case-by-case basis. This functionality allows for applying rules and logic to specific data elements, groups of questions, or entire sections of a document, as well as needed supporting documents based on what the user inputs as he completes the form. It can include showing or hiding parts of the form, requiring certain information, and creating custom alerts based upon user actions.

In other aspects, there are provided apparatus and systems configured to perform the methods as described above. In yet a further aspect, there is provided a computer program comprising machine readable instructions arranged to cause a programmable device to carry out the any one of the methods as described above.

### BRIEF DESCRIPTION OF THE DRAWINGS

There now follows, by way of example only, a detailed description of embodiments of the invention, with reference to the figures identified below.

FIG. 1 is a block diagram showing the main components of a data processing system according to an exemplary embodiment of the invention;

FIG. 2 is a flow diagram illustrating the main processing steps performed by processing components in the system of FIG. 1, to generate a layout template according to an exemplary embodiment;

FIGS. 3A and 3B illustrate exemplary field elements and element properties, respectively, of a database table used in connection with an exemplary embodiment of the present invention;

FIG. 4 illustrates an exemplary process for setting up conditional and calculated fields using a user interface;

FIG. 5, which comprises FIGS. 5A and 5B, is a flow diagram illustrating the main processing steps performed by processing components in the system of FIG. 1, to process an electronic form according to an exemplary embodiment;

FIG. 6, which comprises FIGS. 6A to 6E, are exemplary user interfaces illustrating how user input to a conditional form element of an electronic form is processed to affect the generation of subsequent portions of the electronic form;

FIG. 7, which comprises FIGS. 7A to 7C, are exemplary user interfaces illustrating how different user input to a conditional form element affects the generation of subsequent portions of the electronic form;

FIG. 8 illustrates an exemplary process for the interoperability of the conditional engine and the calculation engine within the form processor;

FIG. 9 is a flow diagram illustrating the main processing steps performed by processing components in the system of FIG. 1, to rebuild an electronic document according to an exemplary embodiment; and

FIG. 10 is a diagram of an example of a computer system on which one or more of the functions of the embodiments may be implemented.

### DETAILED DESCRIPTION OF THE EXEMPLARY EMBODIMENTS

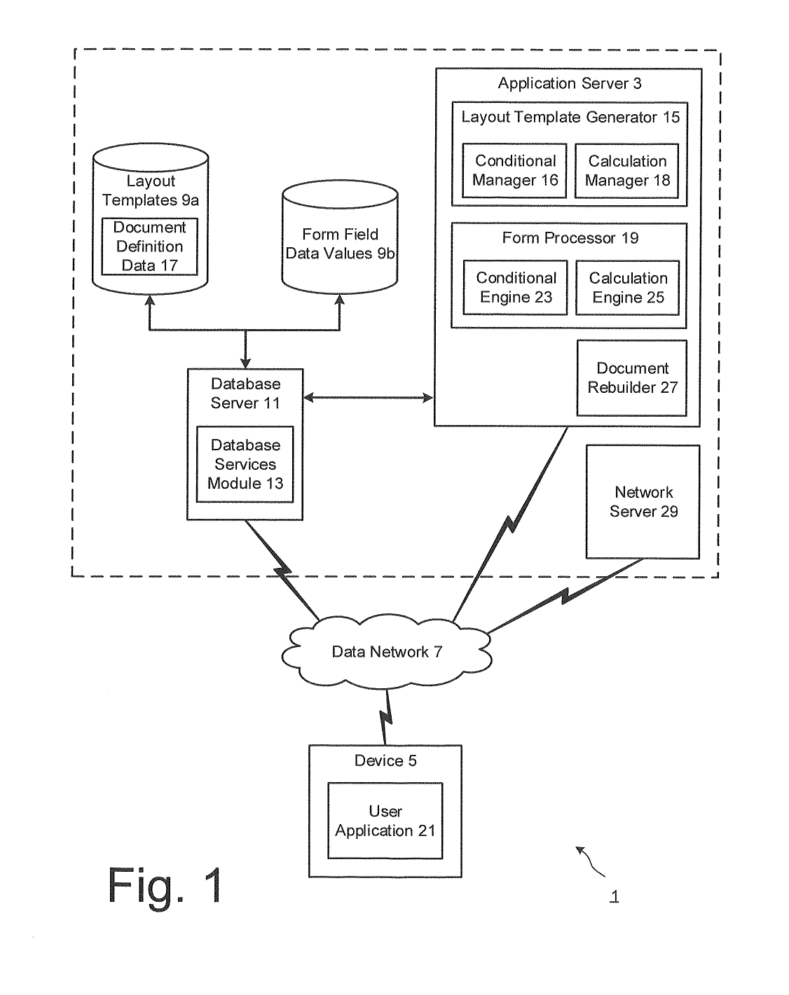

FIG. 1 is a block diagram of an example data processing system 1 configured to lay out dynamic electronic forms and to generate digital form documents therefrom. In this exemplary embodiment, the system 1 employs a client/server architecture and includes an application server 3 in communication with a user's computing device 5, via a data network 7. As shown in FIG. 1, the data that may be used as an input to the application server 3 and the outputs from the application server 3, such as generated layout templates 9a and data values 9b to populate form field elements defined in the layout templates, are stored in respective separate databases 9. The databases 9 may be relational databases; however, other types of data organizational structure may be used. The application server 3 may be in communication with the databases 9 via a database server 11, which may include a database services module 13 that manages storage and retrieval of data from the databases 9. It will be appreciated that the application server 3 may instead be configured with local databases 9 for storing the generated layout templates 9a and the associated form field data values 9b.

In this embodiment, the application server 3 includes a layout template generator 15 that facilitates generation of document definition data 17 based on an input base document, the document definition data 17 defining at least the types and positions of form elements in the base document. The layout template generator 15 stores the generated document definition data 17 as a layout template in a first database 9a, thereby keeping separate the dynamic aspects of the digital form document from data values associated with the form elements of the digital form. The layout template generator 15 includes a conditional manager module 16 and a calculation manager module 18 including executable instructions to receive input to configure dynamic conditions and attributes of the form elements in the generated document definition data 17, for example via the user application 21.

The application server 3 also includes an electronic form processor 19 that dynamically generates an electronic form based on a layout template associated with a digital form document, the electronic form defining input data fields for receiving corresponding data values input via a user application 21 on the device 5. The form processor 19 stores the received data values corresponding to elements of the digital form in a separate database 9b. In this embodiment, the form processor 19 is configured with a conditional engine 23 and calculation engine 25, each defining a respective set of rules that may be associated with one or more form elements defined in a layout template 9a, for example as configured by the conditional manager module 16 and the calculation manager module 18 of the layout template generator 15. The conditional engine 23 provides dynamic field generation based on certain answers to questions or form field data values and may be used in conjunction with the calculation engine 25, providing a powerful set of functionality that allows a user to create highly customizable digital form documents that can morph and change based on both the conditional and calculated value of a field or other variable within the system 1. Further, the calculation engine 25 provides complex formulas to the system to provide deep mathematical capability for in-field calculation, multi-field calculation and calculation based conditional changes.

The application server 3 also includes a document rebuilder 27 that rebuilds the digital form document based on document definition data 17 of a layout template retrieved from the first database 9a, and the associated data field values retrieved from the second database 9b. The document rebuilder 27 may rebuild a digital form document on demand, when required. In this way, the system 1 is configured to dynamically generate digital form documents whereby the conditional and calculation rule structures are not hard coded into the document itself. The digital form document, dynamic fields, and conditional rules are all fully integrated into a process; the digital form document is not a self-contained document. Instead, it is part of a workflow and process based from a specifically generated set of rules and calculations within a dynamic electronic form based system. Once all the form data is entered via the form processor 19, conditional rules applied and calculations completed, the digital form document is then rendered by the document rebuilder 27. This allows additional functionality to be incorporated into the digital form document, closer integration with other sub-systems (not shown) and easier accessibility of the form field data 9b.

To the extent data and information is communicated over the data network, one or more network servers 29 may be employed to deliver content that can be accessed through the data network 7, for example by an end user employing computing device 5. When data is requested through the user application 21, such as an Internet browser, the network server 608 may receive and process the request, for example using the application server 3. The network server 29 may send the data or application requested along with user interface instructions, such as an electronic form generated by the form processor 19, for display as a user interface on the device 5. Thus, for example, a user may employ device 5 to configure a layout template via the layout template generator 15 and/or input data into a configured electronic form via the form processor 19.

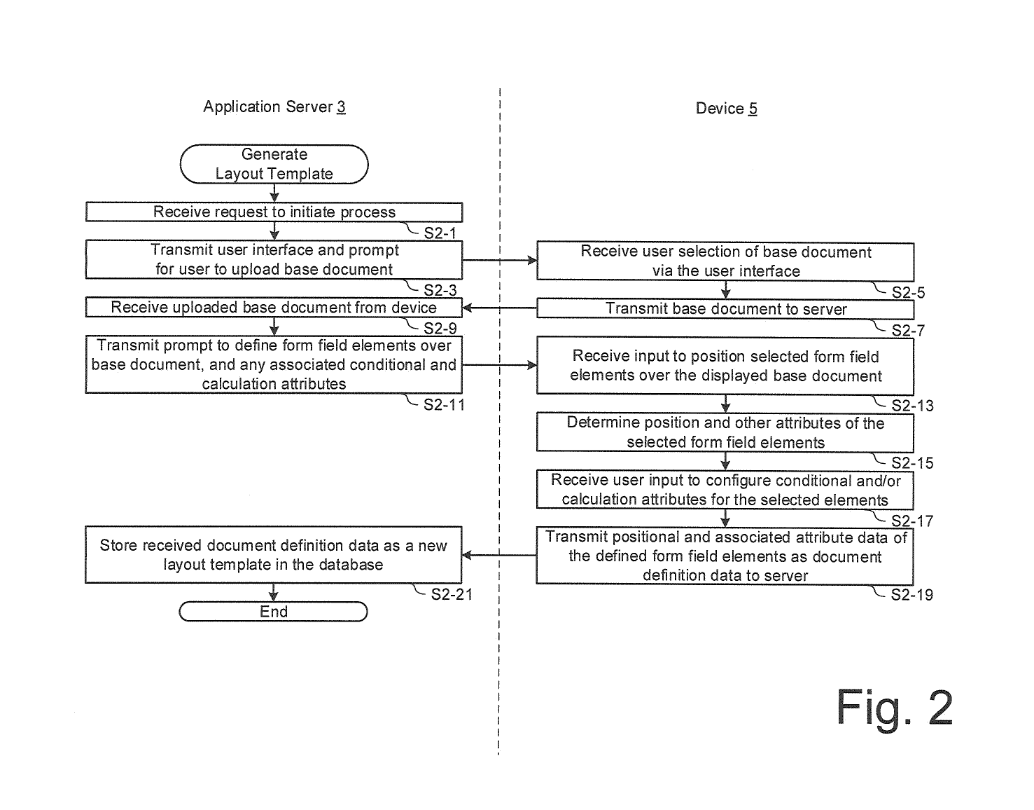

FIG. 2 is a flow diagram illustrating a process for generating a layout template from a base form document using the layout template generator 15, in accordance with an exemplary embodiment of the present invention, including creating the form elements, and generating the conditional and calculation rules. In this embodiment, the layout template generator 15 is configured to transmit data defining a user interface suitable for display by a web browser application 21 of the device 5. It will be appreciated that the user application 21 may instead be configured with data defining the user interface and executable instructions defining the process flow at the device 5.

As shown in FIG. 2, the application server 3 receives a request to initiate a template generation process at step S2-1, for example from the user application 21 at the device 5. In response, the layout template generator 15 of the application server 3 may transmit, at step S2-3, data defining a user interface and a prompt to the device 5 for the user to upload a base document, such as a digital form in PDF file format. At step S2-5, the device 5 receives user selection of the desired PDF form, and the selected base document may be uploaded from the device 5 to the application server 3 through a file upload process at step S2-7. The user may browse his computer file system to find the desired file, and upload the selected PDF via the user application 21. The uploaded PDF form is received by the application server 3 at step S2-9 and stored for use as a base template for creating the conditional field elements. As will be described in further detail below, the document rebuilder 27 of the application server 3 uses the on-page coordinates for the form element positional data (which are stored as document definition data 17 in the database 9 along with the form attributes, validation and data) to rebuild the re-compiled PDF. The form element positional data is used to place elements in the correct position on the re-compiled PDF.

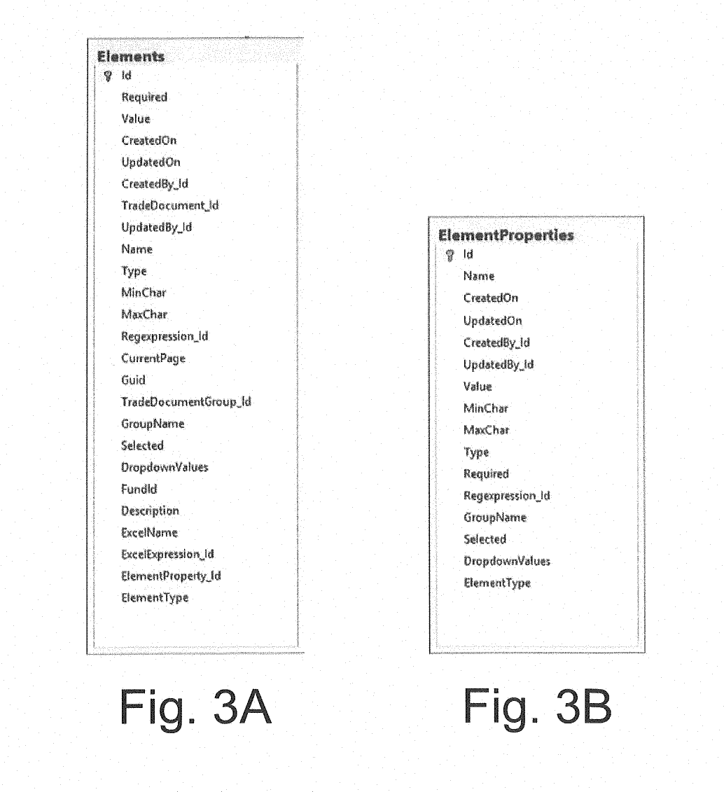

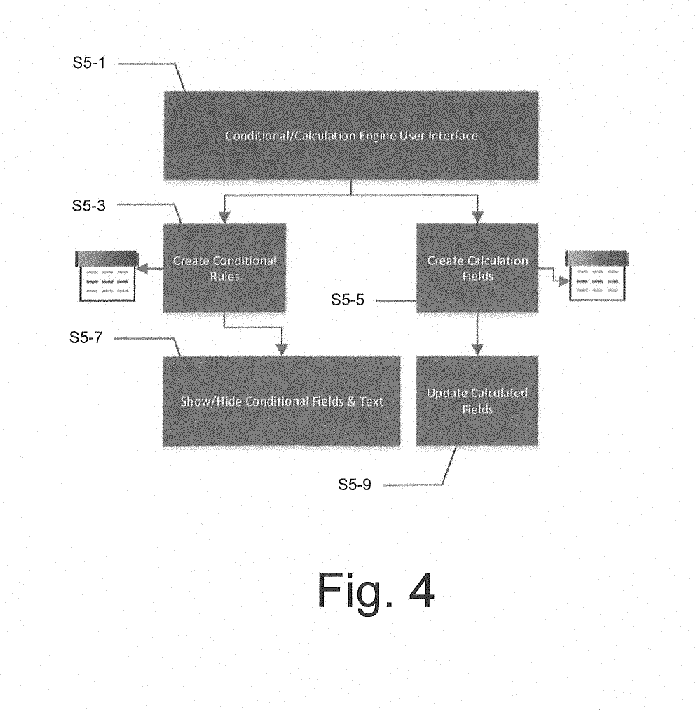

At step 2-11, the application server 3 may transmit a prompt to the device 5 for the user to initiate the process of defining form field elements over the uploaded base document, as well as defining any associated conditional and/or calculation attributes. At step S2-13, the device 5 receives user input to position selected form field elements over the base document displayed via the user application 21. The user application 21 may provide an element designer user interface, enabling the user to drag and drop specific form field elements onto the base PDF form/template corresponding to form field elements where user input values are required. For example, the element designer user interface may display, on the right, the PDF form/template and, on the left, a list of potential field elements that may be included on the form. The field elements on the left can be dragged and dropped onto the form on the right. At step S2-15, the device 5 determines data regarding the position of the form field element and configuration data for the form field element. The position data for an element may be stored in the form of X/Y co-ordinates, such as dimension.XPos: 73, dimension.YPos: 264.2. The element's coordinates may be defined relative to a defined fixed origin of the base document, such as a top-left corner of the form. Alternatively, the element's coordinates may be defined relative to another form field element, such as the previously positioned element. The element's width and height attributes may be stored for example as dimension.width: 210.95, dimension.height: 28.80. Additional exemplary form field element attributes are set forth in FIGS. 3A and 3B, such as a unique identifier, a field type, field data restrictions and/or requirements, associated document page and/or section identifiers, and default/preset values. In the present embodiment, the form/template that includes the form field elements is not used to store any process or input data; once the form field elements are configured, the original form/template is maintained for compliance use only.

At step 2-17, the device 5 receives user input to configure each element as a specific data type, and optionally to enter a conditional rule directly into the element's configuration form, thereby setting a conditional field attribute for the element. Thus, for example, once a field element is dragged and dropped onto the form/template, the user may select a positioned element via the user application 21 and the user interface may be configured to provide a user-selectable option to edit Control Properties of that element. After clicking on the Edit option, the user may be provided with full control over the element and its functions. The user can also add executable formulas into the elements configuration forms. Conditional rules can be any operator on text or numerical values. When the condition is met, the output can be used to affect the next set of form fields to be filled in. The formula calculations can be used to either calculate the value of multiple element fields in the form or used in conjunction with the conditional rules to influence downstream form fields as needed. The combination of the conditional rules and calculation engines make the conditional systems extremely versatile and powerful with no limit forced on the user for the complexity and depth of the rules engines and number of fields within a given conditional rule, calculation or combination of both.

More specifically, the user designing the form can indicate the element type (e.g., checkbox, text, dropdown, radio, signature, initials). The element may also be associated with a name, a description, and a flag defining whether an associated data value is required for completing the form. In addition, certain form field elements may have underlying utilities. For example, for some field elements (e.g., transaction amount, investor name, ID, account ID), not only will the information on the document be in the captured location, but the information will also be sent to a separate system (e.g., a transaction processing system). Once the control properties are set, the position and size of the element can be modified. Manual signatures may be set, as well as electronic signature options.

In addition to configuring the base document with the desired form field elements, the end user must also configure the elements by indicating how they relate to one another. In so doing, the user creates sections, groups and configured form field elements; this ensures that no unrelated elements are affecting each other. The user interface may include a feature to allow for searching form field elements in a document; this ensures that all elements are accounted for in the desired sections and groups.

Still further, the user may configure the conditions for the form using the conditional manager 16 of the layout template generator 15, for example via the user application 21. Using the conditional manager 16, the user selects a new conditional or selects an existing conditional to edit. The user may add affecting and affected elements to the selected conditional. The affecting elements will either show or hide the affected elements if they fulfill a certain criterion. An ‘and/or’ button may be provided to control how the affecting elements relate to each other. The user can make the affected element required, prompt a hard warning or prompt a soft warning. The user may set up multiple conditions for determining how one group of elements behaves. An example of this occurs when configuring dropdowns. Dropdown elements can be set up by listing all the desired options between concatenations. In some instances, depending on the type of user filling out a form, they may need to fill out pages that are entirely different from the pages required to be filled out by others. In this instance, certain elements that determine the type of entity filling out the form may include a condition that direct the entity to a certain group or entire section.

Additionally, the user may configure the calculations for the form using the calculation manager 18 of the layout template generator 15, for example via the user application 21. The user may add a new calculation or edit an existing calculation, thereby setting a calculation field attribute for the element. The user locates a desired target element (e.g., Total Amount) and may then build the calculation for that element using variables (i.e., other elements, such as Subscription Amount, Commission Amount) and formulas.

At step S2-19, the device 5 transmits the positional data and associated attributes of the configured form field elements as document definition data 17 to the application server 3. At step S2-21, the application server 614 stores the received document definition data 17, including the element position data and associated attributes, as a new layout template in the database 9a. It will be appreciated that the user application 21 may be configured to transmit the element's positional and attribute data to the application server 3 for storage as a data component of the document description data 17, as each element is positioned over the base document.

FIG. 4 illustrates an exemplary process for setting up conditional and calculated fields using a user interface of the user application 21. The interface facilitates creating the rules, field names and attribute values, saving them to the database and creating the runtime versions of the conditional and calculation operators. The output of the conditional engine 23 rule modifies an affected field or type. These can be elements, documents, groups, steps or warnings.

In step S4-1, the user application 21 initiates the interface. The interface receives user selection of an element field type and input to drags the element onto the field mapping screen. The interface may guide the users via displaying the base document uploaded at the beginning of the process, as described above with reference to FIG. 2. The interface receives user input to drop the element field on top of a space of the base document where user input is required. In step S4-3, the user application 21 receives user input to open the configuration page for an element and set any configurable attributes of the parent element field. Field attributes include name, ID, validation, and operator, by way of example. Once an element field is configured, the interface enables the user to move on to configure the next element field.

In step S4-5, the user application 21 receives user input to configure calculated field element types in the same manner as conditional field types. The user application 21 also allows for warning flags to be displayed for conditions where a validation rule is not met. These flags can be simple warnings or can prevent a user continuing if certain field conditions are not met.

In step S4-7, for conditional element fields, a particular element and associated text is made to appear or be hidden by the user application 21 depending on the conditional rule set and the value of the associated data input element fields (e.g., if element field “a” is true and element field “b” is true show element field “c”, else show element field “d”).

In step S4-9, for calculation element fields, the user application 21 may be configured to display the result of the calculation of two or more elements in the corresponding calculated field. For example, if element field “a” value is 25 and element field “b” value is 3 and element “c” default is 8, and the calculation function is set to a*b/c, and when the calculation engine runs the calculated field will be set to a value of 9.375 (i.e., 25*3/8).

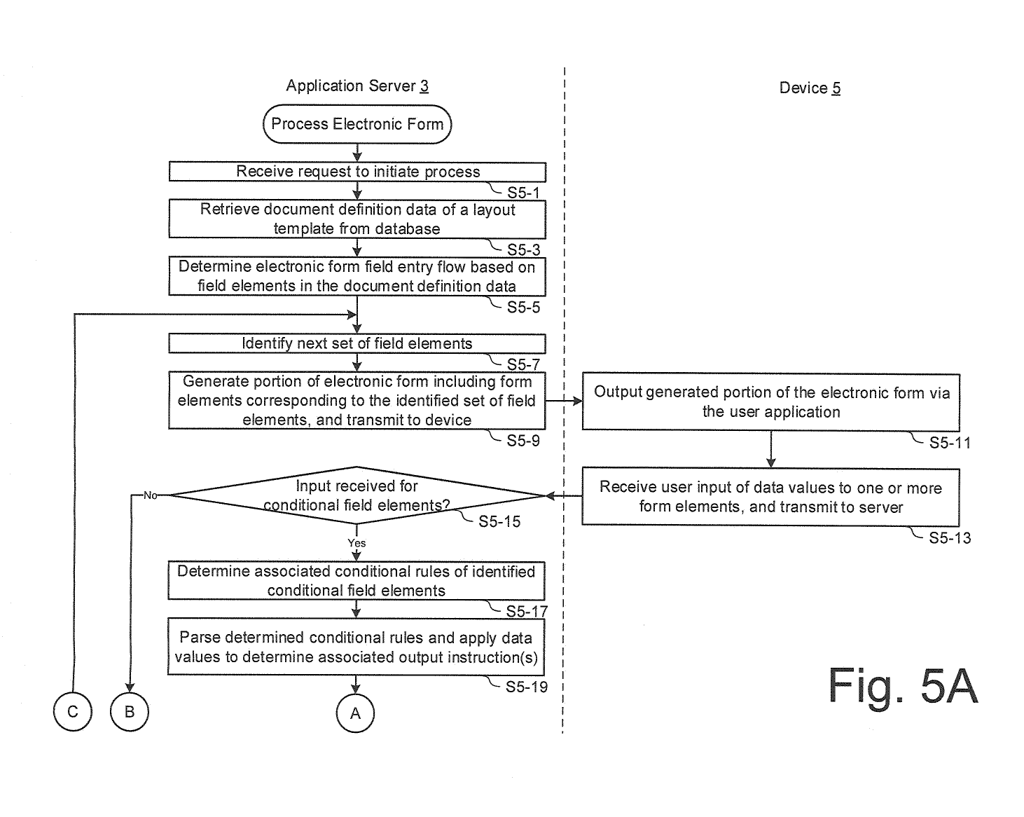

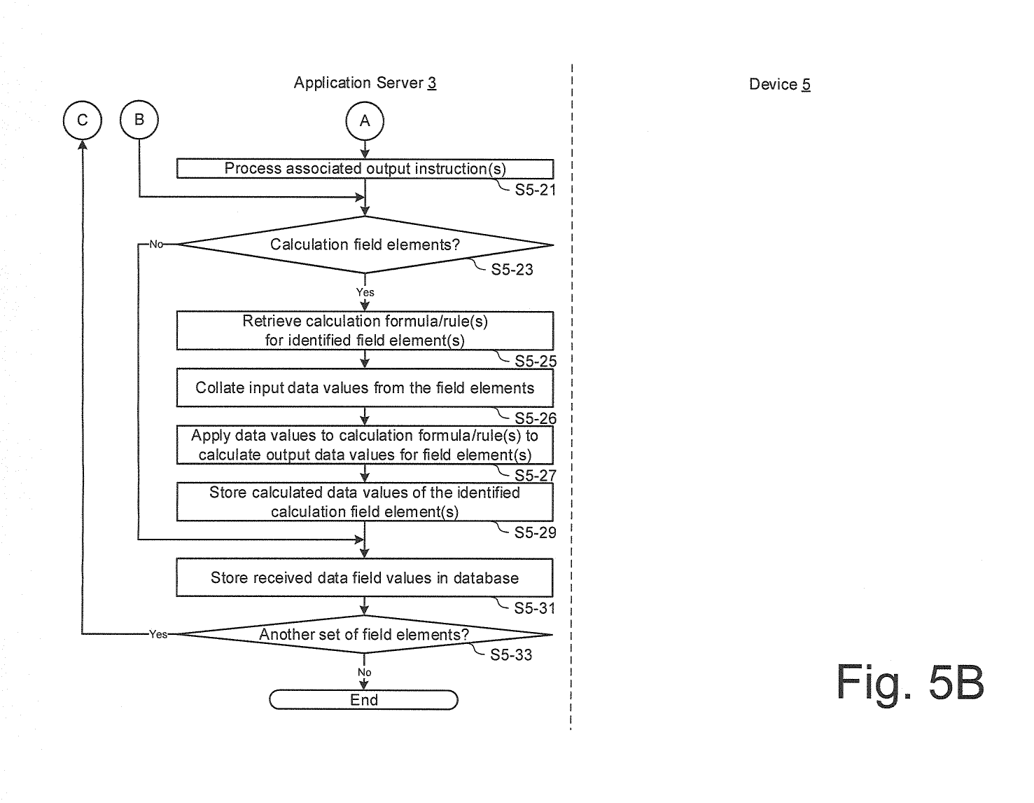

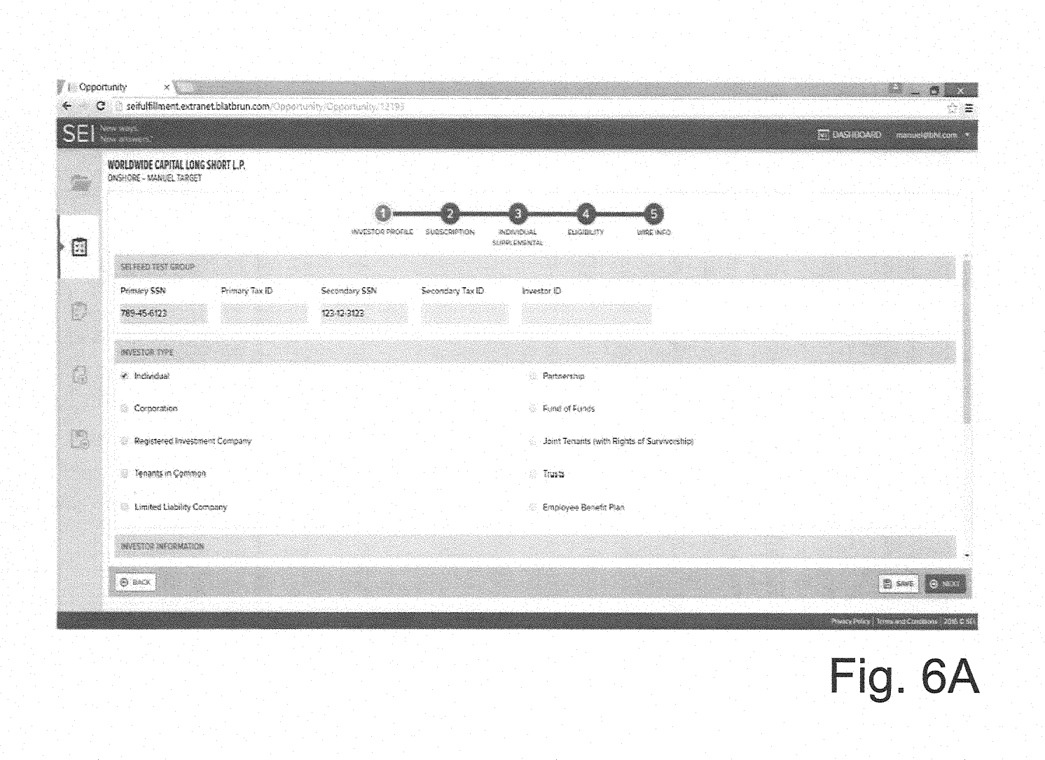

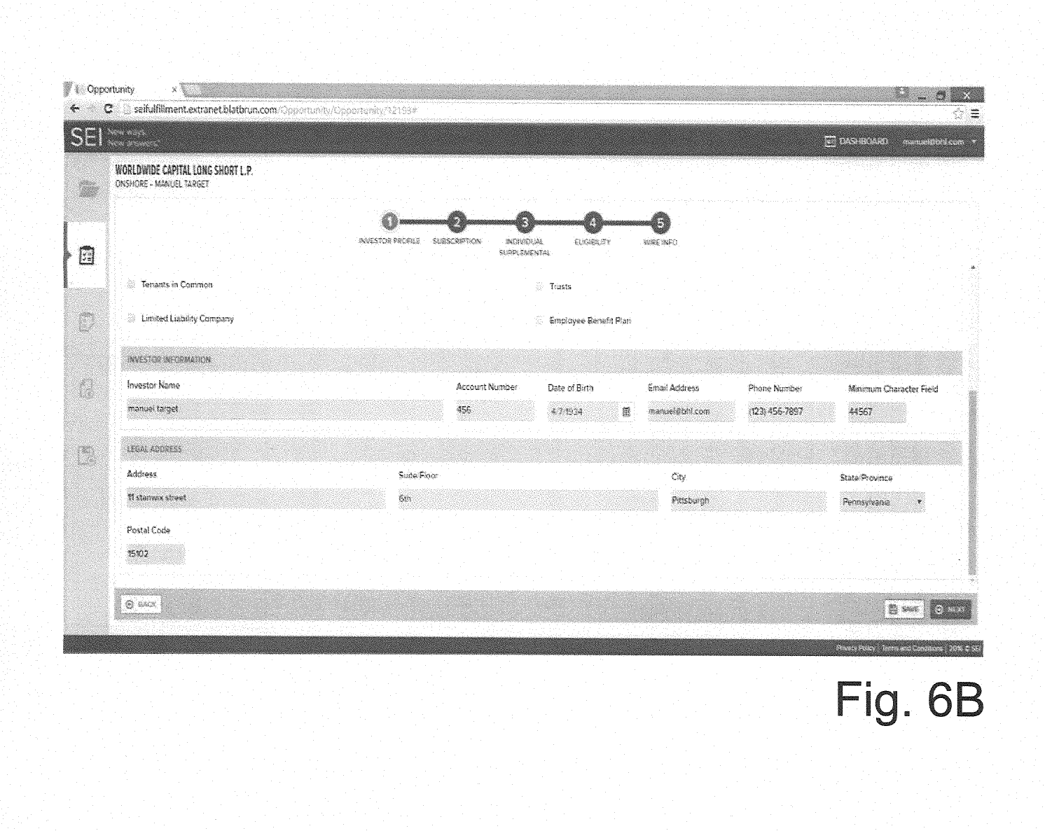

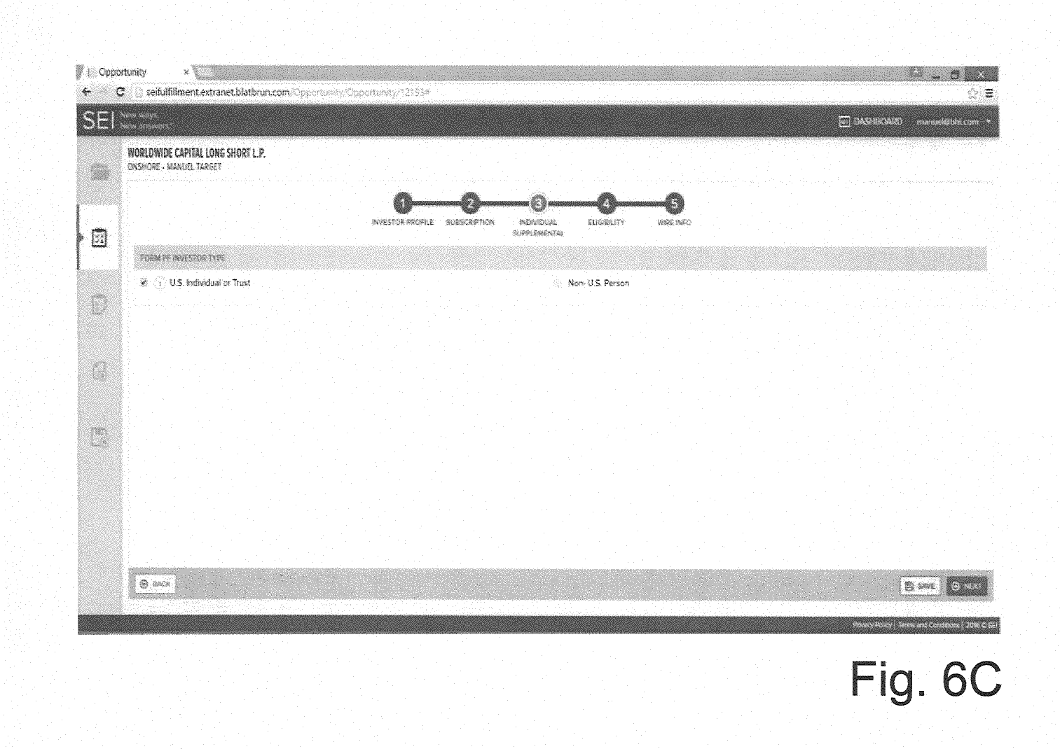

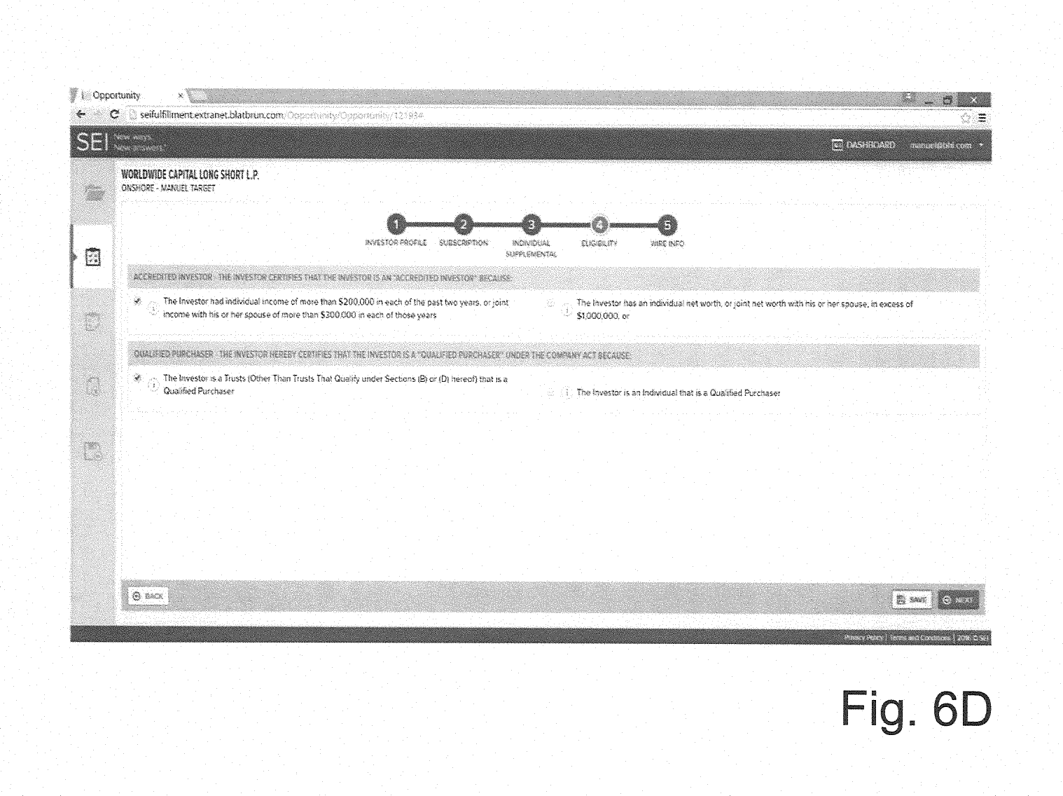

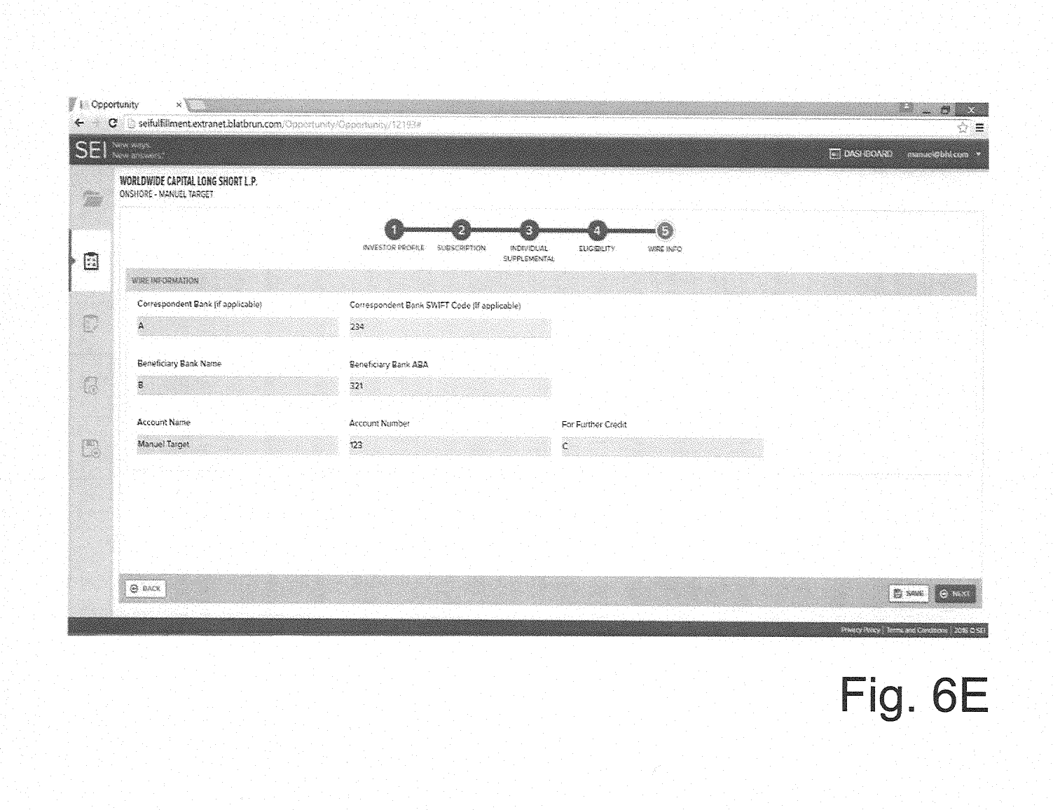

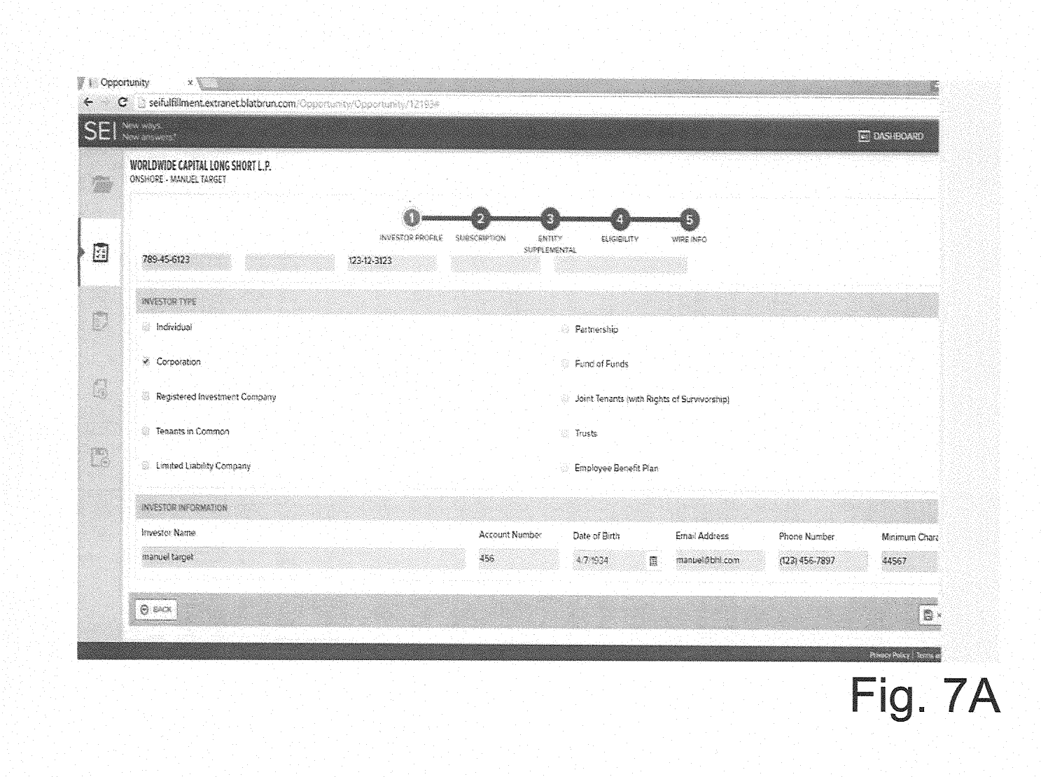

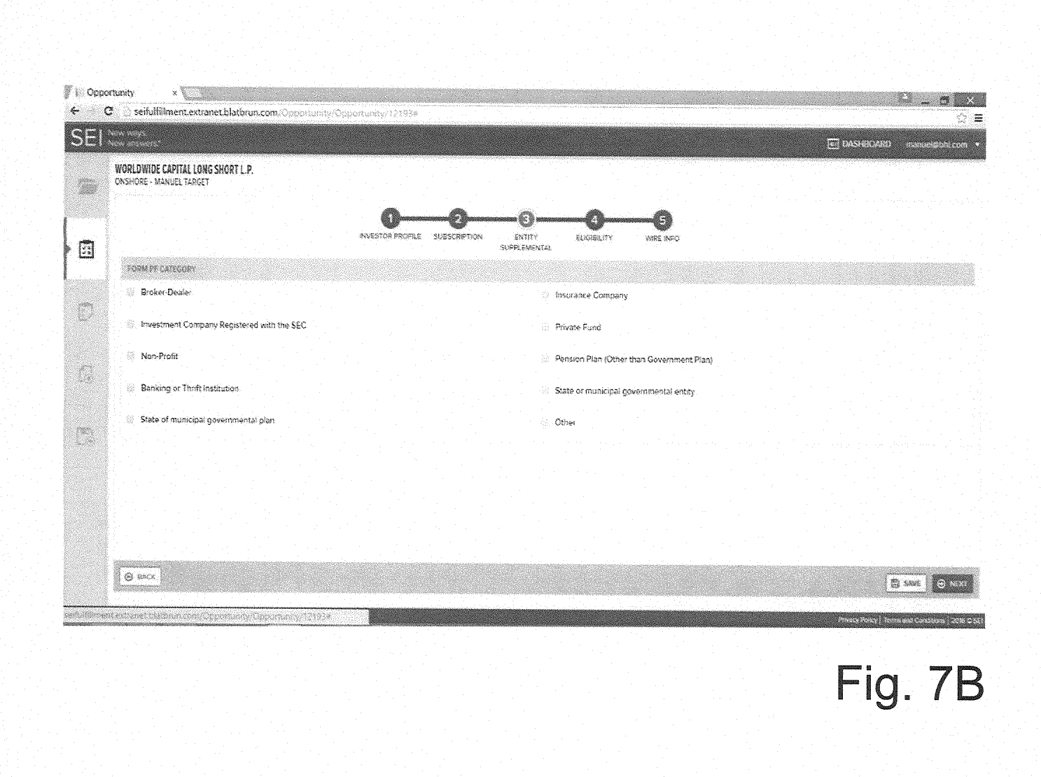

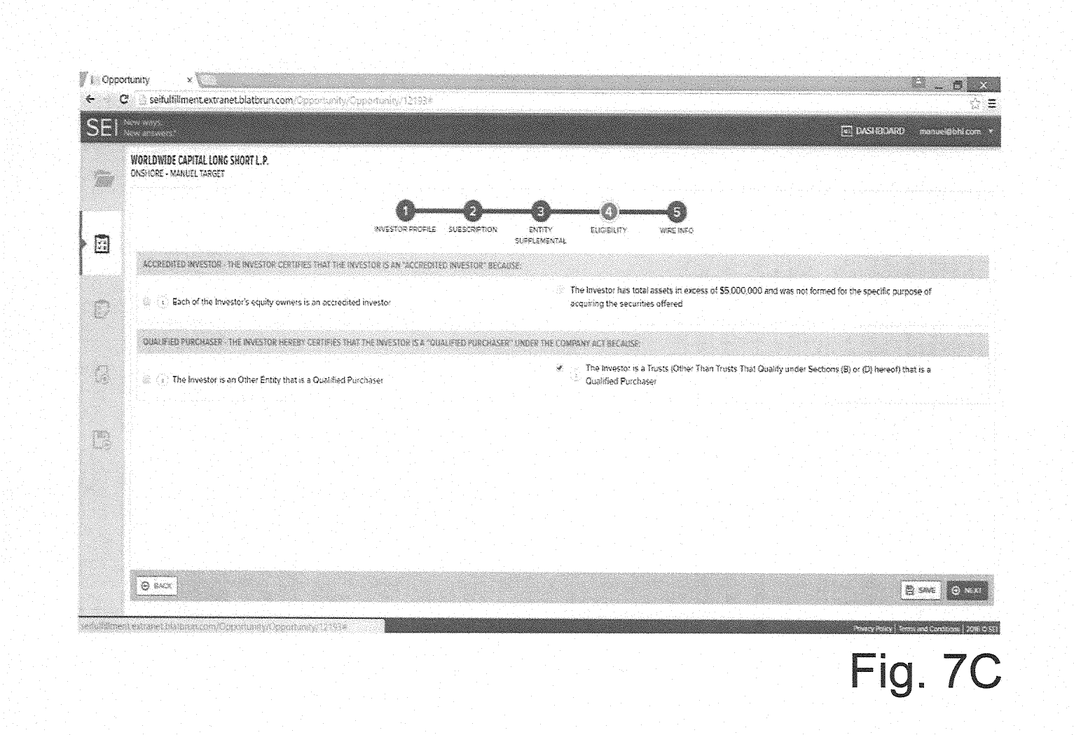

As used herein, an element refers to a user input field or a calculated or conditional result field. Group refers to several elements grouped together. A step refers to a group of groups containing many elements. Warning refers to an informational flag and can be of two types: a soft warning is an informational warning to alert a user that information may be missing; and a hard warning which prevents a user from continuing until a required field is updated. Conditional refers to a rule using elements as input data and affecting an output from the conditional engine. Calculation refers to an engine that uses element data as input for the mathematical function and affects the value of another element. Affecting elements are those that are used as input data for the conditional and calculation engines. Affected elements are those element fields and affected types that are changed by the conditional and calculation engines. Affected Types are the system objects that can be changed by the conditional and calculation engines and can be documents; element values; groups; steps; and warnings. Process data is any data entered into the system element fields that the system uses to modify the downstream elements that will be displayed dynamically. Input data is any data that a user enters into the element fields that will be used to populate the final document. FIG. 5 is a flow diagram illustrating a process for dynamically generating an electronic form based on a generated layout template, and receiving user input of data values to the form field elements using the form processor 19, in accordance with an exemplary embodiment of the present invention. In this embodiment, the electronic form is a web form suitable for display on a web browser application 21 of the device 5. Reference is also made to FIG. 6, which comprises FIGS. 6A to 6E, and FIG. 7, which comprises FIGS. 7A to 7C, showing exemplary user interfaces illustrating how user input to a conditional form element of a web form is processed to affect the generation of subsequent portions or sections of the web form.

As shown in FIG. 5, the application server 3 receives a request at step S5-1 to initiate a process of generating and processing an electronic form based on an identified base document or layout template 9a, for example from the user application 21 at the device 5. In response, the form processor 19 of the application server 3 retrieves the document definition data 17 associated with the identified base document or layout template, from the first database 9a, for example via the database services module 13 of the database server 11. At step S5-5, the form processor 19 determines, for example using the custom-developed conditional and calculation engines 23,25, an electronic form field entry flow for the dynamic electronic form, based on the retrieved document definition data 17 defining field elements and associated attributes, for example as input in the layout template configuration process described above with reference to FIG. 2. For example, the form field element attributes may include a display order, and a corresponding document page and/or section identifier, as defined in the stored document definition data 17. The form processor 19 may determine the electronic form field entry flow based on these element attributes, for example defining a plurality of sets of field elements based on groups of page/section identifier attribute, and within each set, display and/or priority ordering based on the field identifier attribute.

At step S5-7, the system generates data defining a first portion of the web form having a first set of input field elements, for example based on the grouping and order defined by the entry flow. At step S5-9, data defining the generated portion of the web form is transmitted to the device 5, and the received web form elements are rendered and output by the browser application 21 at step S5-11. At step S5-13, the device 5 receives user input of data values to one or more elements of the web form, and the browser application 21 transmits the input data fields back to the application server 3.

In this embodiment, as the user inputs data into each field element of the web form, the form processor 19 is configured to determine one or more input form field elements to be dynamically displayed in the next section or portion of the web form, based on the data entered in previous form field elements. FIGS. 6 and 7 are exemplary user interfaces illustrating how an individual selection on a first page of a web form may affect the information required to be entered on subsequent pages in accordance with post-conditional rule flow, for example as controlled by the conditional engine 23 of the form processor 19. It will be appreciated that although the exemplary web pages shown in FIGS. 6 and 7 generally relate to an investment opportunity, but underlying technical functionality can be used in connection with creation and completion of electronic forms in any context. In FIG. 6A, the investor enters information about himself and, because he has indicated he is an individual, the next screen to appear (FIG. 6B) is additional information requested that is pertinent to an individual. With reference to FIG. 6C, a further screen appears asking the individual to indicate whether the individual is US or non-US. With reference to FIG. 6D, a screen with eligibility questions is displayed to the individual, the questions included thereon relating to eligibility for an individual investor. In FIG. 6E, the individual may include his wire (e.g. bank account) information.

FIG. 7 illustrates an alternate sequence of web form screens as a result of processing different user input to a conditional form element compared to FIG. 6A. With reference to FIG. 7A, the investor instead enters information about itself and, because the user has indicated that the investor is a corporation, the form processor 19 generates a different conditional configuration which affects the downstream data entry requirements. For example, FIG. 7B illustrates a subsequent web form section prompting the user to indicate the type of corporate entity, rather than a type of individual entity as shown in FIG. 6C. Similarly, FIG. 7C illustrates a subsequent web form section including eligibility questions that are applicable to a corporate entity. The conditional and calculation engines 23,25 may be configured to run at each user input step and display data entry questions and fields depending on the current element field rules. Both conditional and calculation engines 23,25 may run in conjunction and independent of each other depending on the configuration of the rule.

Thus, the conditional engine 23 accepts data from input fields in a form and performs conditional operations on the data from single or multiple fields. Then, based on user configurable rules, the conditional engine 23 alters the next piece of input information required to complete the process. In this way, the system 1 works dynamically based on changing criteria. For example, the conditional rule on a particular field may specify: if the user enters “Yes” in the element field in section B of the form, then the next section of the form to be displayed is section C; but if the user enters “No” in the element field in section B of the form, then the next form section displayed is section F.

Accordingly, returning to FIG. 5, at step S5-15, the form processor 19 determines if input data was received into one or multiple field elements having conditional field attributes.

For example, the conditional engine 23 may process the data from all the input fields and check for any fields linked to a conditional rule or attribute. If so, at step S5-17, the conditional engine 25 determines and sets up the conditional rules for each identified element field. Rules can be based on, for example, if, then, else, and, or, true, false, equals, greater than, or less than. At step S5-19, the conditional engine 23 parses each of the associated conditional rules, for example in the order and priority set during configuration. For example, the conditional engine 23 may collate all data required to meet the conditions defined in the conditional rule(s) and run the rule operation(s) against the current data set (i.e., against the data contained in the element field data in the order set by the field ID).

In this way, the conditional engine 23 applies the data values from associated element fields as input parameters to the respective conditional rule(s), to determine when the specified conditions are met by the data values, and to determine one or more associated output instructions. At step S5-21, the form processor 19 processes the determined output instructions, for example to identify one or more groups of form field elements to be provided in respective subsequent portions of the web form. The output of the conditional engine 23 depends on the data provided and the conditional rule operations. The output instructions can be instructions to change any field element, question tag and data type, depending on the rule definition.

After the form processor 19 has determined that all identified conditional field elements have been processed, or if the form processor 19 determines at step S4-15 that there are no conditional field elements to process, then processing proceeds to step S4-23. At step S4-23, the form processor 19 determines if there are any field elements in the web form that have calculation field attributes. Alternatively, the form processor 19 may determine if input data was received that affects field elements having calculation field attributes. If so, the calculation engine 25 can also be used to dynamically create and/or populate calculated fields within the form. These calculated fields can refer to any other element field within the current form. The calculation engine 25 has the capability of processing complex calculations.

For example, the calculation engine 25 may be used to perform mathematical operations on any field data within the form, including a conditional or condition based field. The calculation engine 25 may receive and process data values as entered by the user to the web form and/or data values as prepopulated into the form elements. Additionally or alternatively, the data can be input to the calculation engine 25 through a user input field, fixed value field, default value field or the output from the conditional engine 23.

At step S5-25, the calculation engine 25 retrieves the calculation formulae or functions defined for the identified calculation fields. At step S5-26, the calculation engine 25 collates all data values from the element fields. At step S5-27, the calculation engine 25 calculates output data values for the identified calculation field elements based on the collated input data values and the specified calculation formulae or functions. Data may be actioned based on the ID of the field element and the type of function configured. At step S5-29, once the calculation is complete, the calculation engine 25 then passes the calculated value to the output field specified in the element configuration, whereby the output field value is reflected as the calculated value. The calculation engine 25 also stores the calculated data values in the form field data values database 9b.

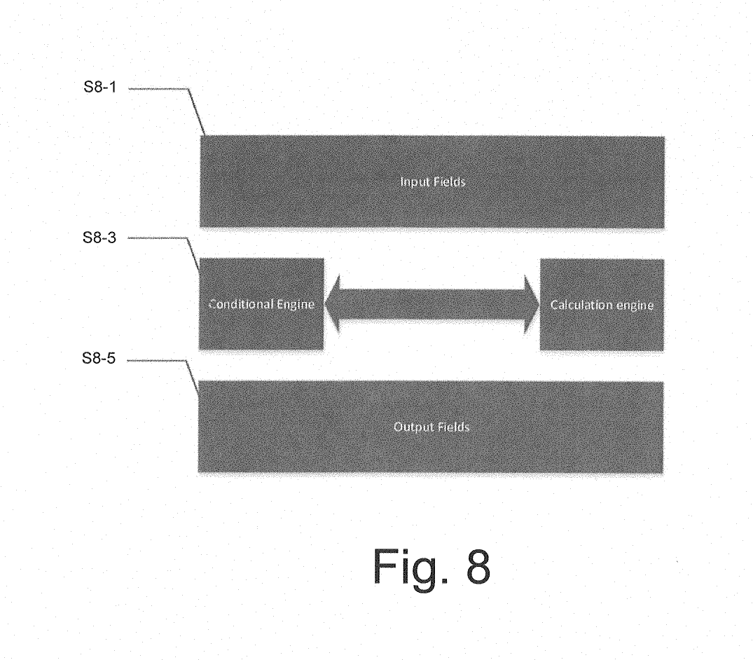

Alternatively or additionally, the calculation engine 25 may be configured to work in a second mode, where the conditional engine 23 and the calculation engine 25 are interoperable within the form processor 19. FIG. 8 illustrates an exemplary process for the interoperability of the conditional engine and the calculation engines within the form processor 19. The calculation engine 25 can work in conjunction with the conditional engine 23 to generate very complex conditional rules that can be used for complex form generation based on any criteria that is configured within the application server 3. In such an arrangement, both engines may work together, in parallel or as primary/secondary modes, to provide complex data behavior based on user input, text field conditional rules, calculated values, recalculated values and default values.

For example, at step S8-1, values are read from the data input fields and can be any combination of data entry, calculated, condition based, default values. This data is then made available to both engines 23,25. At step S8-3, depending on the ID of the field element, the conditional and calculation engines 23,25 will perform their data operations in the correct sequence defined by the ID numbers. The engines can also be setup to take authority in a primary/secondary calculation scenario so that the correct order of operation can be performed. At step S8-5, once the calculations are complete, the resulting data is either passed to the output fields for display or the output questions and data input types are modified based on the conditional rules met.

Returning again to FIG. 5, in this embodiment, every time data is entered into a field and a conditional rule has been satisfied, the form processor 19 stores the input data values to a database record as an attribute or child of the document object, at step S5-31. At step S5-33, the form processor 19 determines if there is another set of field elements in the document definition data 17 to be processed, for example based on the remaining portion of the entry flow determined at step S5-5 and/or the output instruction(s) determined from parsed conditional rules at step S5-19. If so, processing returns to step S5-7 where the form processor 19 repeats the process for a subsequent portion of the electronic form.

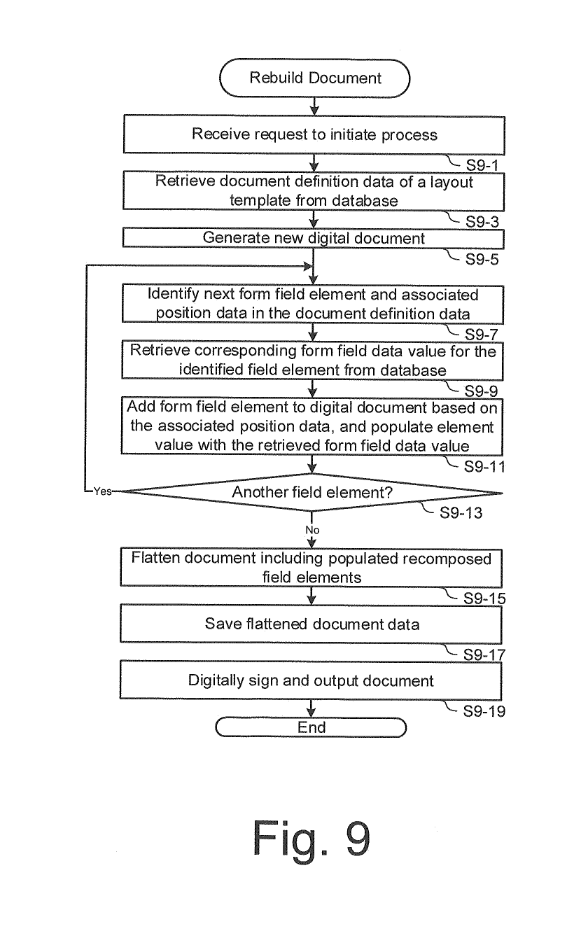

FIG. 9 the document rebuilder 605c initiates a final document creation process, for example when all the data has been entered and processed by the form processor 19 as described above with reference to FIG. 4. The final digital document is prepared from the stored information in the databases 9, as the databases 9 contain all the data necessary to recreate the original base document with the new conditional rules, calculations, form fields, and data values. As shown in FIG. 9, the application server 3 receives a request at step S9-1 to initiate a process of rebuilding a digital document based on an identified base document or layout template 9a, for example from the user application 21 at the device 5. In response, the document rebuilder 27 of the application server 3 retrieves the document definition data 17 associated with the identified base document or layout template, from the first database 9a, for example via the database services module 13 of the database server 11.

At step S9-5, the document rebuilder 27 generates a new digital document, for example based on document metadata defined in the. At step S9-7, the document rebuilder 27 identifies the next form field element in the retrieved document definition data 17, this being the first element to be added to the digital document, for example based on an order defined by the element ID attribute. The document rebuilder 27 also identifies the associated positional data of the form field element, as well as any other associated attributes, from the retrieved document definition data 17. At step S9-9, the document rebuilder 27 retrieves the corresponding form field data value from the second database 9b, as received and stored by the form processor 19 in the process described above with reference to FIG. 5. At step S9-11, the document rebuilder 27 adds data defining the form field element to the digital document, including data defining the output coordinates in the digital document and other associated attributes defined in the retrieved document definition data 17. The document rebuilder 27 also populates the element's data value attribute with the corresponding data value retrieved from the form field data value database 9b. At step S9-13, the document rebuilder 27 determines if there is another form field element in the retrieved document definition data 17 to be added to the digital document, and processing returns to step S9-7 for the next element.

Once all of the form field elements defined in the document definition data have been processed, populated with retrieved data values, and added to the digital document, the document rebuilder 27 may perform post-processing to flatten the digital document including the populated recomposed field elements, at step S9-15, for example for increased compatibility with a range of other data processing systems. At step S9-17, the application server 3 may save or store the flattened digital document data, for example in another database (not shown). At step S9-19, the rebuilt digital document may be made available by the application server 3 for user input of a digital signature, and/or output, such as printing, transmission and/or display.

The embodiments described above advantageously provide an improved system to transform existing documents into customized and dynamic, electronic forms, without compromising the integrity of the documents themselves (e.g., in terms of layout, data required to be input, and standard text). Additionally, the system provides an interface, such as a web application, that efficiently and effectively guides users through the necessary steps of a dynamically generated workflow, ensuring that all required information is completed without distracting the individual with information and actions that are irrelevant, thus improving the overall experience for an electronic form processing application.

The system and process described in the foregoing also solves a number of technical problems. More particularly, the system and process described herein facilitates complex, conditional-based, dynamic changes to PDF forms; provides the ability to perform complex math and data calculations, to modify field values, display or hide fields, and use values from several different related forms in calculations or conditional statements; allows for creation of dynamic workflows that link to these conditional and calculated documents; provides drag and drop builds for dynamic PDFs with conditional/calculation attributes; and manages the tracking and positioning of the fields within the PDF so that they can be reconstructed on demand or used as part of other documents. These advantages are achieved through the combination of several different technologies and processes to create a more efficient process for creating dynamic and highly configurable PDF documents. This novel combination of technologies includes the use of conditional statements to produce different paths within the PDF. This is a powerful approach to creating dynamic PDF documents at a basic level for changing the flow of the PDF. Also included in the combination is a calculation engine that interacts with the conditional engine. The calculation engine performs calculations on data entered into a PDF form element and/or combines a calculation with a conditional statement to further enhance the dynamic capability of the PDF system, to produce very powerful dynamic PDFs based on any condition or value or combination. The PDF document is then managed through a custom workflow system which allows an administrator to create complex conditional/mathematical based dynamic PDFs and use those documents within a workflow system.

Also, the fact that the PDF is controlled within the process provides for a higher level of performance and, ultimately, functionality by isolating the conditional/calculation and workflow engines within the overall infrastructure so that each sub-structure can be enhanced separately without impacting the other engines from a technology and process perspective. The information is stored separately in different databases and then the final document is created at run time, which allows the application to perform whatever functions it needs to on the document before run time. This allows for more effective managing of the process and also allows for adding functionality as required at each engine.

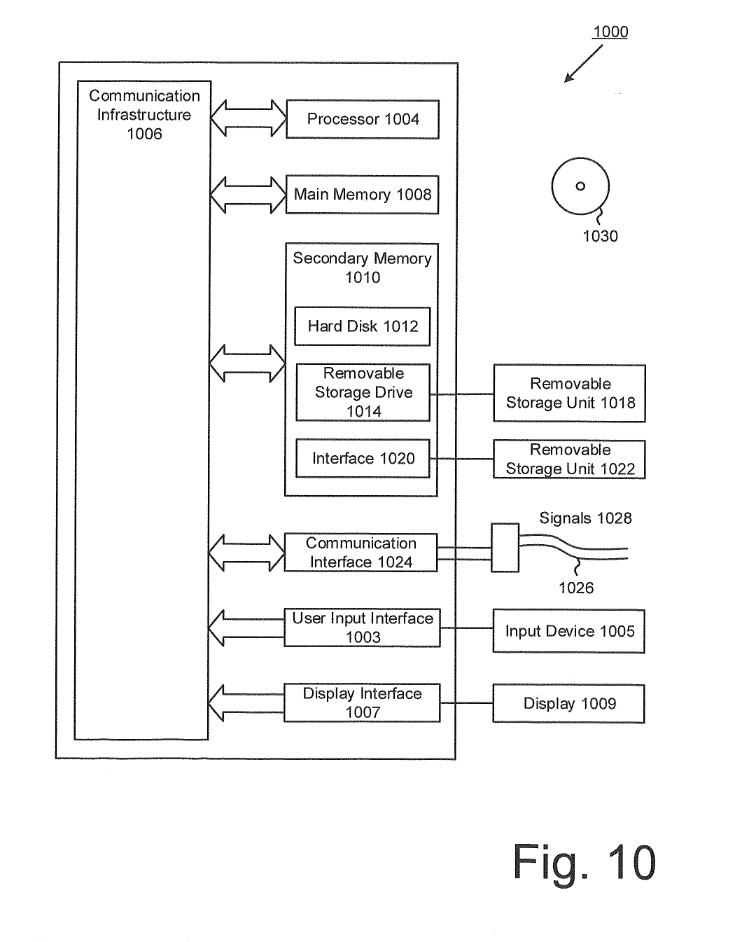

Various aspects of the present invention can be implemented by software, firmware, hardware, or a combination thereof. FIG. 10 illustrates an example computer system 1000 in which the present invention, or portions thereof, can be implemented as computer-readable code. For example, the methods illustrated by the flowchart 200 of FIG. 2 can be implemented in system 1000. Object-selective backup processing architecture 100 of FIG. 1 can also be implemented in system 1000. Various embodiments of the invention are described in terms of this example computer system 1000. After reading this description, it will become apparent to a person skilled in the relevant art how to implement the invention using other computer systems and/or computer architectures.

Computer system 1000 includes one or more processors, such as processor 1004. Processor 1004 can be a special purpose or a general-purpose processor. Processor 1004 is connected to a communication infrastructure 1006 (for example, a bus, or network).

Computer system 1000 also includes a main memory 1008, preferably random access memory (RAM), and may also include a secondary memory 1010. Secondary memory 1010 may include, for example, a hard disk drive 1012, a removable storage drive 1014, flash memory, a memory stick, and/or any similar non-volatile storage mechanism. Removable storage drive 1014 may comprise a floppy disk drive, a magnetic tape drive, an optical disk drive, a flash memory, or the like. The removable storage drive 1014 reads from and/or writes to a removable storage unit 1018 in a well-known manner. Removable storage unit 1018 may comprise a floppy disk, magnetic tape, optical disk, etc. which is read by and written to by removable storage drive 1014. As will be appreciated by persons skilled in the relevant art(s), removable storage unit 1018 includes a non-transitory computer usable storage medium having stored therein computer software and/or data.

In alternative implementations, secondary memory 1010 may include other similar means for allowing computer programs or other instructions to be loaded into computer system 1000. Such means may include, for example, a removable storage unit 1022 and an interface 1020. Examples of such means may include a program cartridge and cartridge interface (such as that found in video game devices), a removable memory chip (such as an EPROM, or PROM) and associated socket, and other removable storage units 1022 and interfaces 1020 which allow software and data to be transferred from the removable storage unit 1022 to computer system 1000.

Computer system 1000 may also include a communications interface 1024. Communications interface 1024 allows software and data to be transferred between computer system 1000 and external devices. Communications interface 1024 may include a modem, a network interface (such as an Ethernet card), a communications port, a PCMCIA slot and card, or the like.

Computer system 1000 may additionally include computer display 1030. According to an embodiment, computer display 1030, in conjunction with display interface 1002, can be used to display UI 115 on operator console 110. Computer display 1030 may also be used to display output from the user application, for example as depicted in FIGS. 5 and 6.

In this document, the terms “computer program medium,” “non-transitory computer readable medium,” and “computer usable medium” are used to generally refer to media such as removable storage unit 1018, removable storage unit 1022, and a hard disk installed in hard disk drive 1012. Computer program medium, computer readable storage medium, and computer usable medium can also refer to memories, such as main memory 1008 and secondary memory 1010, which can be memory semiconductors (e.g. DRAMs, etc.). These computer program products are means for providing software to computer system 1000.

Computer programs (also called computer control logic) are stored in main memory 1008 and/or secondary memory 1010. Computer programs may also be received via communications interface 1024. Such computer programs, when executed, enable computer system 1000 to implement the present invention as discussed herein. In particular, the computer programs, when executed, enable processor 1004 to implement the processes of the present invention, such as the steps in the methods illustrated by flowcharts of FIGS. 2, 4, 8 and/or 9, and system architecture 1 of FIG. 1 discussed above. Accordingly, such computer programs represent controllers of the computer system 1000. Where the invention is implemented using software, the software may be stored in a computer program product and loaded into computer system 1000 using removable storage drive 1014, interface 1020, hard drive 1012, or communications interface 1024.

The invention is also directed to computer program products comprising software stored on any computer useable medium. Such software, when executed in one or more data processing device, causes a data processing device(s) to operate as described herein. Embodiments of the invention employ any computer useable or readable medium, known now or in the future. Examples of non-transitory computer readable storage media that store the programs (i.e., software modules comprising computer readable instructions) may include volatile and non-volatile, removable and non-removable media implemented in any method or technology for storage of information such as computer-readable instructions, data structures, program modules, or other data. Computer readable storage media may include, but is not limited to, RAM, ROM, Erasable Programmable ROM (EPROM), Electrically Erasable Programmable ROM (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computer system and processed.

It will be understood that embodiments of the present invention are described herein by way of example only, and that various changes and modifications may be made without departing from the scope of the invention.

The systems and methods of the present invention include the combination of the several processing engines that run separately or integrated and provide different technologies to produce an enhanced and efficient user experience for creating complex documents and workflow from within a custom application. For example, in the embodiments described above, the processing by the conditional engine and calculation engine is performed at the application server 3. As those skilled in the art will appreciate, alternatively or additionally, the functionality provided by the conditional engine and calculation engine may be included as computer-executable instructions within the electronic form data itself.

As yet another alternative, the separate processing modules of the application server 3, may be provided as one or more distributed computing modules or processing services on one or more remote servers that are in communication with the application server via the data network. Additionally, as those skilled in the art will appreciate, the application server functionality may be provided as one or more application programming interface (API) accessible by an application program executing on the device, or as a plug-in module, extension, embedded code, etc., configured to communicate with the application program.

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the method does not rely on the particular order of steps set forth herein, the particular order of the steps should not be construed as limitation on the claims. The claims directed to the method of the present invention should not be limited to the performance of their steps in the order written, and one skilled in the art can readily appreciate that the steps may be varied and still remain within the spirit and scope of the present invention.

1. A method of generating an electronic form suitable for display by an application on a device based on a template from a database of a server, said method comprising the steps of:
receiving from the device a request for the electronic form;
retrieving a template of the requested form, the template including document definition data defining at least one field element of the requested form;
generating an electronic form suitable for display by the application on the device based on the retrieved document definition data, the form including at least one input element, corresponding to the at least one field element defined in the document definition data;
transmitting at least a portion of the generated form to the device over a communication link for display by the device;
receiving at least one data value associated with a respective input element of the generated form; and
storing the received data values separate from but associated with respective field elements in the document definition data, wherein the stored document definition data and the associated stored data values can be used to generate a corresponding digital form document.

2. The method of claim 1, further comprising transmitting a second portion of the generated form dependent upon at least one received data field value.

3. The method of claim 2, further comprising generating the second portion of the generated form in response to processing said at least one received data field value.

4. The method of claim 3, further comprising upon receiving said data value input into an input element of the electronic form, determining another input element of the electronic form based at least on the received data value

5. The method of claim 1, wherein determining another input element of the electronic form comprises processing the input data value in accordance with at least one conditional rule associated with the input element of the electronic form.

6. The method of claim 5, wherein said at least one conditional rule is further associated with one or more output instructions.

7. The method of claim 6, wherein the output instructions include transmitting said data value to another data processing system.

8. The method of claim 5 or any claim dependent therefrom, further comprising calculating a data value for said another input element of the electronic form based on at least said input data value.

9. The method of claim 1, wherein the document definition data includes position attribute data for each field element defining a position of the field element in a generated digital form document.

10. The method of claim 1, wherein the document definition data is derived from a base document.

11. The method of claim 10, further comprising providing an interface to receive input to create said template, the interface configured to receive input identifying fields elements for receiving data values, configure associated conditions for the field elements specifying one or more actions based on data values input into the field elements, and configure calculations performed on the data values input into the field elements.

12. A computer implemented method comprising:
identifying fields in a template for receiving inputted data; conditions specifying one or more actions based on the data inputted into the fields; and calculations performed on the data inputted into the fields;
creating the electronic form based on the template and the identified fields in the template;
displaying the electronic form and receiving data input into the fields of the electronic form,
wherein, upon receiving data input into at least one field of the electronic form, identifying another field of the electronic form for inputting data, the identifying based on the data input into the at least one field of the electronic form;
storing data describing the electronic form separate from but associated with the data input into the at least one field of the electronic form; and
generating a completed electronic form from the stored data describing the electronic form and the stored data input into the at least one field of the electronic form stored in the database.

13. A system comprising:
a first user interface configured to allow a first end user to create an electronic form based on a template by identifying fields in the template for receiving inputted data; conditions specifying one or more actions based on the data inputted into the fields; and calculations performed on the data inputted into the fields;
a conditional engine processor and a calculation engine processor configured to create the electronic form based on the template and the identified fields in the template;
a second user interface configured to display the electronic form and receive data input into the fields of the electronic form,
wherein, upon receiving data input into at least one field of the electronic form by a second end user, identifying to the second end user another field of the electronic form for inputting data, the identifying based on the data input into the at least one field of the electronic form;
a database that stores data describing the electronic form separate from but associated with the data input into the at least one field of the electronic form; and
one or more processors that generates a completed electronic form from the stored data describing the electronic form and the stored data input into the at least one field of the electronic form stored in the database.
